(19) United States
(12) Patent Application Publication
(10) Pub. No.: US 2018/0210820 A1
(43) Pub. Date: Jul. 26, 2018

(54) AUTOMATIC APPLICATION SCRIPT INJECTION SYSTEM

(71) Applicant: CA, Inc., New York, NY (US)

(72) Inventors: Ramesh Mani, Fremont, CA (US); Arivoli Tirouvingadame, Fremont, CA (US)

(21) Appl. No.: 15/414,936

(22) Filed: Jan. 25, 2017

(51) Int. Cl. G06F 11/36

(52) U.S. Cl. CPC G06F 11/3676; G06F 11/3688

(57) ABSTRACT

In various embodiments, a method of automatically injecting an application script into application code may be performed. The method may include injecting an application script at an automatically identified first location within application code of a web page. The method may further include sending the application code including the application script to a web browser. The method may further include determining, based on whether metrics corresponding to the application script are received from the web browser, whether to automatically identify a second location within the application code at which to instead inject the application script.

### BACKGROUND

### Technical Field

This disclosure relates generally to an automatic application script injection system.

### Description of the Related Art

Some software providers may wish to monitor how their software performs on computer systems (e.g., user computer systems) that run the software. One way to monitor this performance is by including an application performance management (APM) script within the software. APM scripts may monitor execution of the software and send metrics regarding the monitored execution to the software provider.

### SUMMARY

In various embodiments, an automatic application script injection system is disclosed that automatically identifies a location within application code of a web page and injects an application script at the location. In response to receiving an indication of metrics corresponding to the application script, the automatic application script injection system may preserve an indication of the location. As a result, in some cases, the application script may be injected at the location in future web responses to web browsers without first attempting other locations. In response to receiving an indication that metrics corresponding to the application script have not been received, the automatic application script injection system may automatically identify another location within the application code or may determine not to inject the application script into the application code.

### BRIEF DESCRIPTION OF THE DRAWINGS

FIG. 1 is a block diagram illustrating one embodiment of a system that includes an automatic application script injection system.

FIGS. 2A-F are block diagrams illustrating a process of automatically injecting an application script into application code.

FIG. 3 is a flow diagram illustrating one embodiment of a method of automatically injecting an application script into application code.

FIG. 4 is block diagram illustrating an embodiment of a computing system that includes at least a portion of an automatic application script injection system.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a computer system that runs six applications, the terms “first application” and “second application” can be used to refer to any two of the six applications, and not, for example, just a first two applications to be started.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

An automatic application script injection system is disclosed herein that automatically identifies a location within application code and injects an application script at that location. The application code including the application script may be sent to a web browser as part of a web response (e.g., in response to a web request from the web browser). For example, an application script such as application performance management (APM) script that causes the web browser to generate metrics indicative of performance of the application code may be sent to the web browser as part of a web response. In some embodiments, the automatic application script injection system may track the location where the application script is injected. Further, the automatic application script injection system may determine whether to automatically identify a different location within the application code and instead inject the application script at the different location. The application code including the application script at the different location may be sent as part of a second web response (e.g., to the web browser or to a different web browser).

As a result of the automatic application script injection system, injection locations within application code may be automatically identified. Further, the automatic application script injection system may automatically determine whether injecting an application script at a particular location causes a failure of at least a portion of the application code. The automatic application script injection system may identify a location at which to inject the application script more quickly, as compared to a system where injection locations are manually identified.

References are made herein to “injecting” a group of program instructions or programming code into a different group of program instructions or different program code. This process of injection results in displacement of at least one program instruction within the group that is the target of the injection. For example, consider the following sequence of program instructions:

Program instruction 1

Program instruction 2

Program instruction 3.

It may be desired to inject “Program instruction 4” and “Program instruction 5” between instructions 2 and 3, such that the result of the injection is as follows:

Program instruction 1

Program instruction 2

Program instruction 4

Program instruction 5

Program instruction 3.

Injection thus refers to a process in which a first set of programming code is inserted within a second set of programming code, displacing at least a portion of instructions of the second set of programming code.

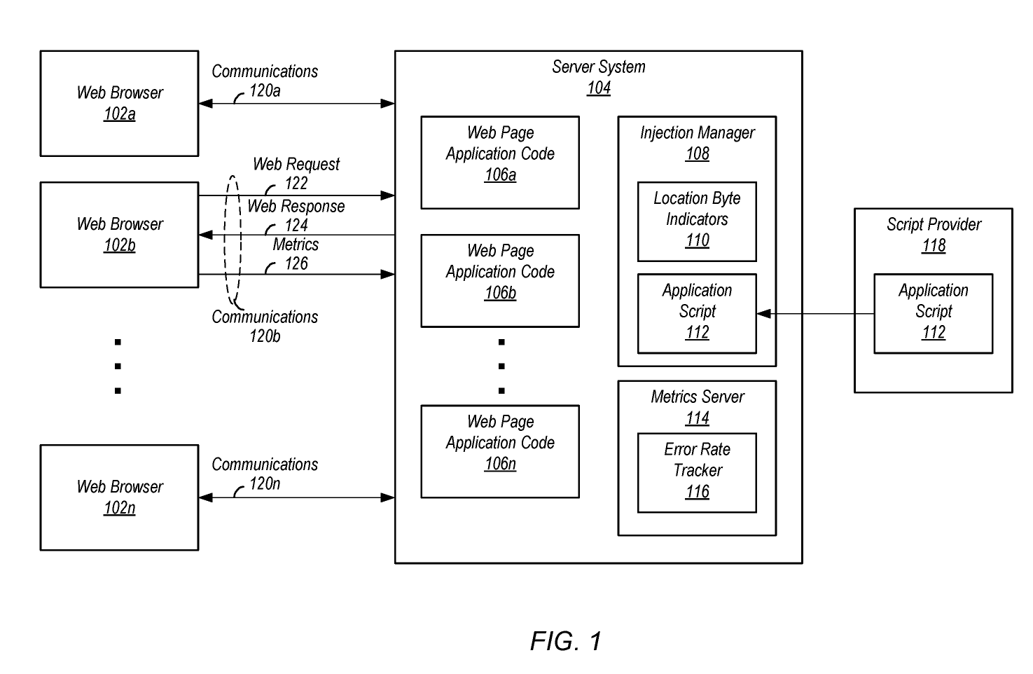

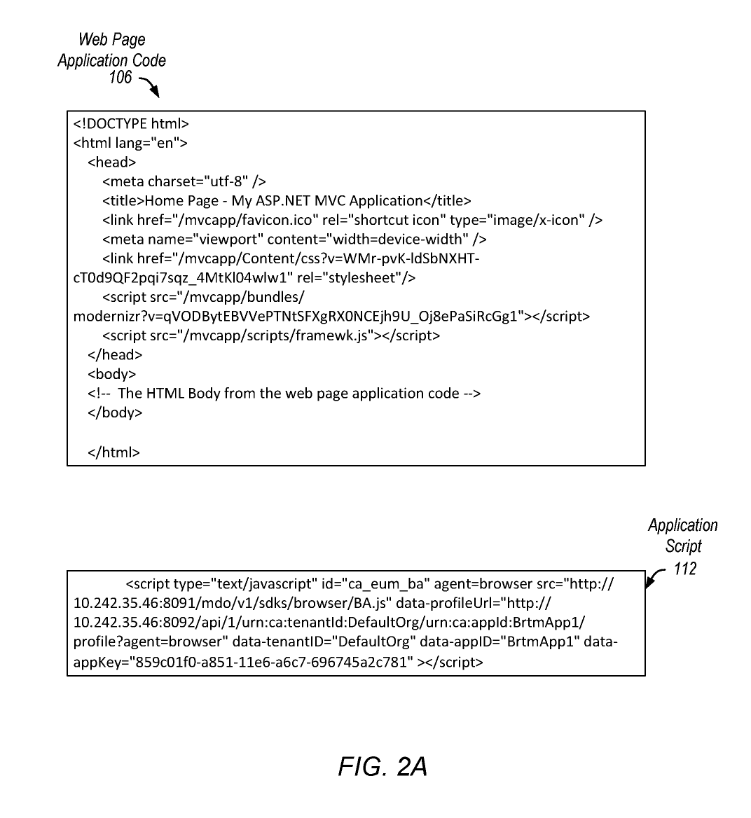

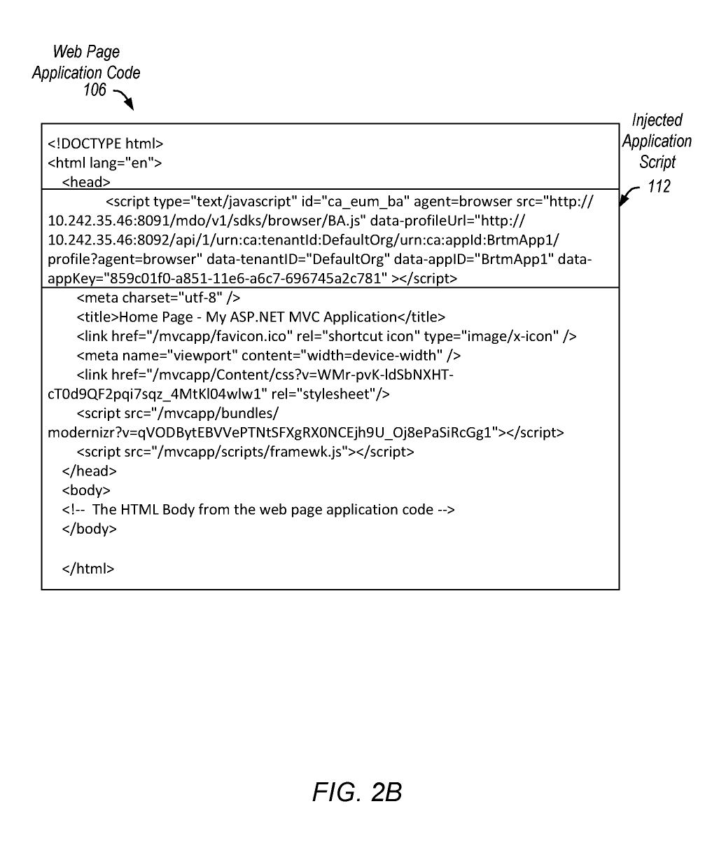

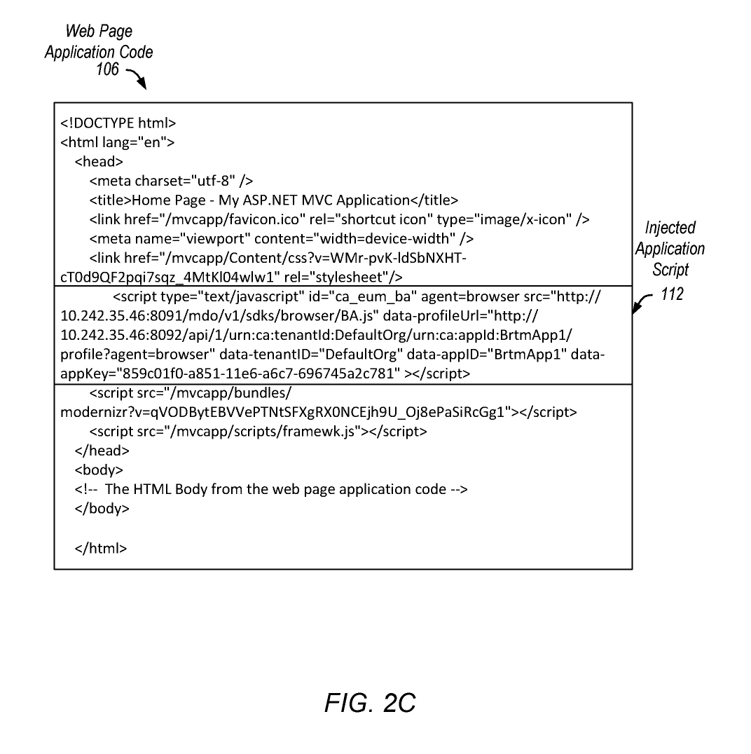

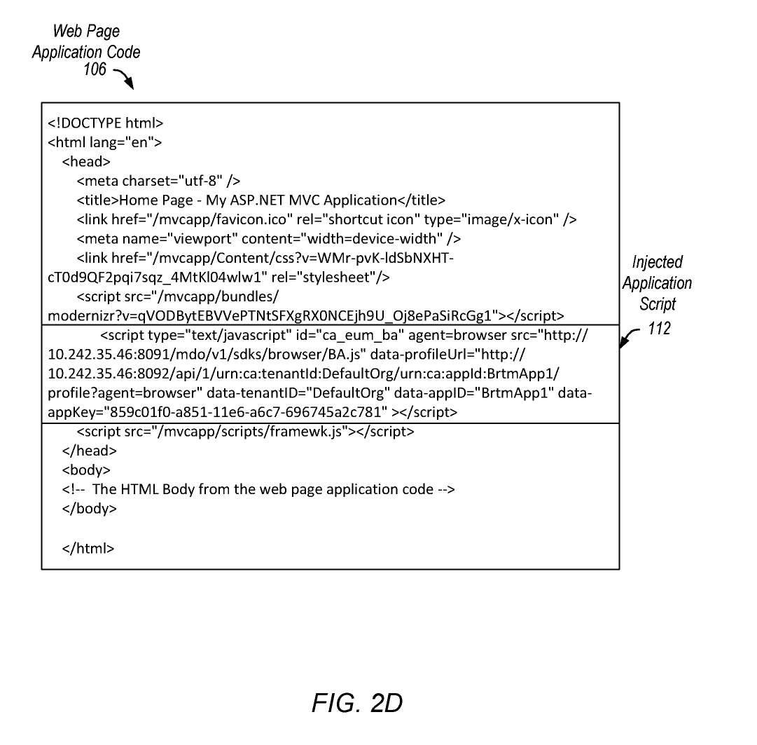

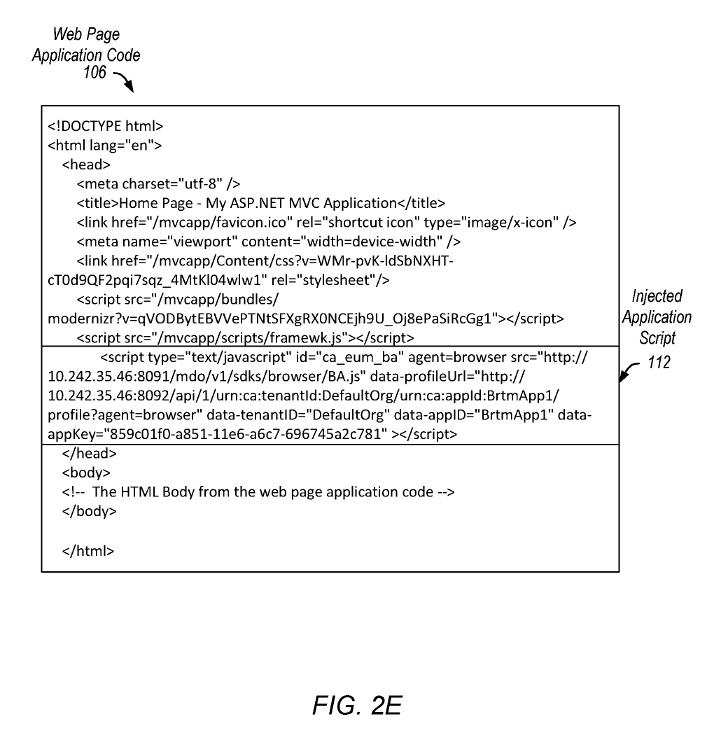

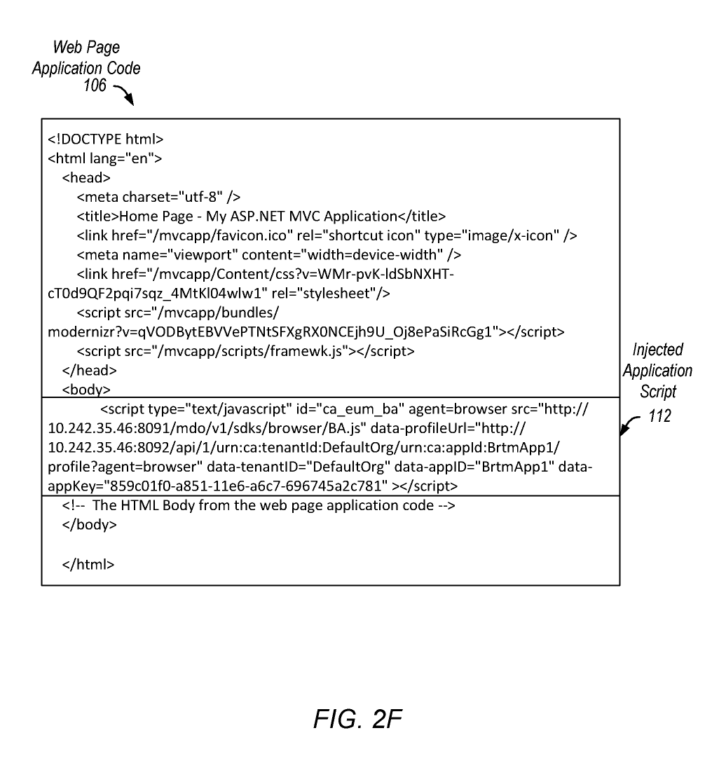

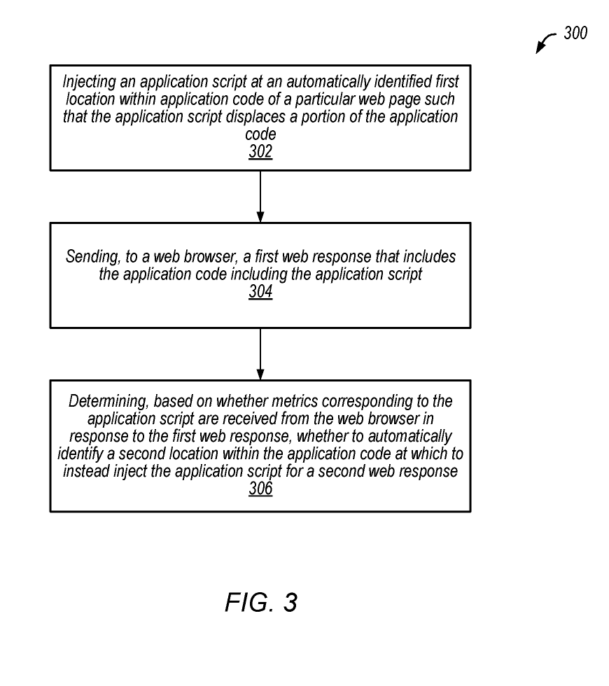

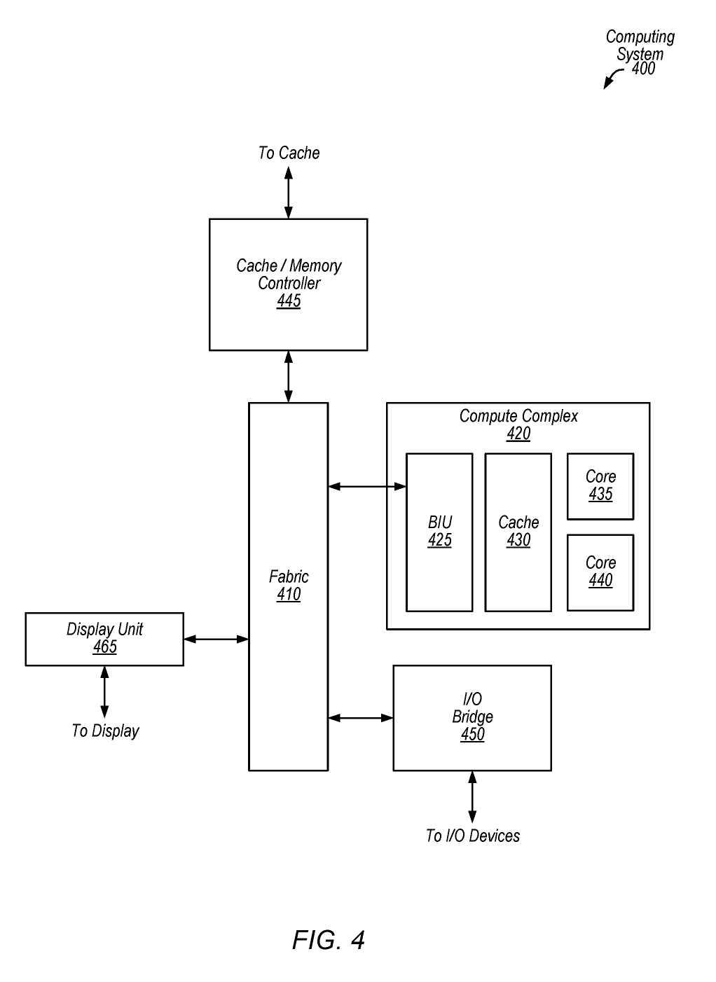

This disclosure initially describes, with reference to FIG. 1, various embodiments of a system that includes an automatic application script injection system. An exemplary process of injecting an application script into various locations within application code is described with reference to FIGS. 2A-F. A method of automatically injecting an application script into application code is described with reference to FIG. 3. Finally, an embodiment of a computing system that includes an automatic application script injection system is described with reference to FIG. 4.

Turning now to FIG. 1, a simplified block diagram illustrating one embodiment of a system that includes an automatic application script injection system is shown. In the illustrated embodiment, the system includes web browsers 102a-n, server system 104, and script provider 118. Server system 104 includes web page application code 106a-n, injection manager 108, and metrics server 114. Injection manager 108 includes location byte indicators 110 and application script 112. Metrics server 114 includes error rate tracker 116. Script provider 118 includes application script 112. In the illustrated embodiment, server system 104 is an automatic application script injection system implemented by a plurality of servers. However, as further described below, in other embodiments, additional or fewer devices may be included in an automatic application script injection system. For example, in some embodiments, injection manager 108, metrics server 114, or both may be separate from server system 104. Additionally, in some cases, injection manager 108, metrics server 114, or both may be managed by an entity different from the entity managing server system 104. Further, in some embodiments, script provider 118 may not be present (e.g., because application script 112 is developed by the entity managing server system 104).

Web browsers 102a-n may send various communications 120a-n to one or more servers of server system 104. In the illustrated embodiment, communications 120b include web request 122 that requests web page application code (e.g., web page application code 106a) for a particular web page corresponding to server system 104. For example, web request 122 may be a Hyper Text Markup Language (HTML) request that requests web page application code for a particular Uniform Resource Locator (URL). One or more servers of server system 104, which may be the same server that received web request 122 or a different server, may send the requested web page application code to web browser 102b as part of web response 124 (e.g., a HTML response). Additionally, in some cases, web response 124 may include application script 112 injected into the requested web page application code. In some cases, as part of executing application script 112, web browser 102b may send metrics 126 to server system 104 (e.g., to metrics server 114) indicating behavior of the web page application code, a computer system running web browser 102b, or both. For example, in some embodiments, metrics 126 may include application performance management (APM) data that indicates timing information regarding the execution of the web page application code by web browser 102b. As another example, web browser 102b may send metrics 126 to a web address specified by application script 112 (e.g., corresponding to metrics server 114). In some cases, application script 112 may cause execution of the web page application code, application script 112 or both to fail at web browser 102b. In such cases, web browser 102b may send metrics 126 to server system 104 indicating the failure or may not send metrics 126 to server system 104. In some embodiments, in response to a failure to execute the web page application code, web browser 102b may send another web request to server system 104 for web page application code for the particular URL.

In some cases, metrics 126 may include at least one of a connection establishment time, a domain processing time, a domain lookup time, a page load time, a page render time, a page stall time, a page unload time, an amount of time until a first byte is received, an amount of time until a last byte is received, or a number of hits per a particular interval. However, these metrics are only provided as an example. In various embodiments, any suitable metric, including navigation timing metrics, performance resource timing metrics, soft page timing metrics, or additional (e.g., custom) metrics may be used.

Server system 104 may communicate with web browsers 102a-n via respective communications 120a-n, including sending web page application code 106a-n to web browsers 102a-n in response to corresponding web requests (e.g., web request 122). Additionally, in the illustrated embodiment, server system 104 may inject application script 112 into one or more of web page application code 106a-n. In particular, as further discussed below with respect to FIG. 2, injection manager 108 may identify a particular location (e.g., a particular byte location) within web page application code 106a and may inject application script 112 into web page application code 106a at the particular location. The particular location may be identified using a set of location detection rules. The location detection rules may specify one or more tags within web page application code 106a that are indicative of potential application script injection locations. If injection manager 108 does not identify a potential application script injection location, injection manager 108 may determine not to inject application script 112 into web page application code 106a. Further, in some embodiments, injection manager 108 may store a location byte indicator in location byte indicators 110, indicating the selected application script injection location. For example, location byte indicator 110 may store a byte number that specifies a byte where the injected application script 112 begins. As another example, location byte indicator 110 may specify an iteration number that indicates a number of potential application script injection locations to bypass. Other forms of identifying the location of the injected application script 112 may also be used. In some embodiments, application script 112 may be injected into the web page application code prior to receiving a web request (e.g., web request 122). In other embodiments, application script 112 may be injected into the web page application code in response to receiving the web request. As noted previously, in some embodiments, the identified application script injection location may be specific to a particular URL included in web request 122. Accordingly, a different URL may correspond to a different application script injection location, even if the web page application code for the two URLs is similar.

In the illustrated embodiment, in some cases, server system 104 may receive metrics as part of communications 120a-n. Communications 120a-n including web responses including application script 112 at a particular location may be sent to multiple web browsers (e.g., web browser 102a and web browser 102b) or to only a single web browser. Additionally, in some cases, a web browser may send multiple instances of the metrics to server system 104. Alternatively, server system 104 may not receive metrics subsequent to sending web page application code including application script 112 to one or more web browsers. In some embodiments, based on received metrics, whether metrics were received, or both, metrics server 114 may, using error rate tracker 116, determine an error rate for injecting application script 112 at a particular location within corresponding web page application code. The error rate may be determined based on metrics (received or not received) corresponding to a single web browser or based on metrics corresponding to multiple web browsers. In response to an error threshold (e.g., 5% or 90%) equaling or exceeding the error rate, additional web responses may be sent including application script 112 at the identified location. In response to the error rate for a particular web page application code being below an error threshold, (e.g., 5% or 90%) metrics server 114 may request that injection manager 108 automatically identify a different location within the corresponding web page application code at which to instead inject application script 112. In response to identifying the different location, injection manager 108 may update the associated location byte indicator. In some embodiments, server system 104 may send another web response to the browser(s) including application script 112 at the different location. In other embodiments, to reduce a response time for the requesting browser(s), server system 104, may determine not to inject application script 112 into a web response for the browser(s) and may instead inject application script 112 into future web responses for future web requests. In some embodiments, in response to modifying the location byte indicator a particular number of times (e.g., 5), injection manager 108 may determine not to inject application script 112 into the web page application code. Accordingly, server system 104 may automatically identify locations within web page application code and may automatically inject application script 112 into the web page application code, moving application script 112 based on whether a corresponding error rate exceeds a corresponding error threshold.

Script provider 118 may be a creator or distributor of application script 112. For example, script provider 118 may be an APM software suite distribution company. Server system 104 may receive application script 112 from script provider 118. In some embodiments, script provider 118 may include metrics server 114 and may receive the metrics from web browsers 102a-n.

Turning now to FIGS. 2A-F, block diagrams illustrating an example process of injecting an application script into various locations of web page application code is shown. For clarity, the illustrated embodiments are described in terms of HTML and javascript pseudocode. However, other messaging protocols or programming languages may be used. Additionally, although the illustrated embodiments show the application script being injected at locations relative to various tags in the web page application code, other tags or methods for automatically identifying injection locations may be used. In various embodiments, web page application code 106 may correspond to at least one of web page application code 106a-n of FIG. 1.

FIG. 2A illustrates web page application code 106 and application script 112 separately. In some embodiments, web page application code 106 illustrated in FIG. 2A corresponds to web page application code where application script 112 has been disabled. FIG. 2B illustrates an embodiment of web page application code 106 and application script 112 where application script 112 has been injected into web page application code 106 after a <head> tag. In some embodiments, FIG. 2B corresponds to a first injection location that may be automatically identified by a system such as server system 104 of FIG. 1.

FIG. 2C illustrates an embodiment of web page application code 106 and application script 112 where application script 112 has been injected into web page application code 106 prior to a <script> tag. In some embodiments, FIG. 2C corresponds to a second injection location that may be automatically identified by a system such as server system 104 of FIG. 1. Accordingly, in response to an indication that an error rate corresponding to FIG. 2B exceeds an error threshold, injection manager 108 may instead inject application script 112 into web page application code 106 as illustrated in FIG. 2C.

Application script 112 may be injected into locations relative to various tags. Accordingly, as shown in FIG. 2D, application script 112 may be injected as shown using a location detection rule that specifies that application script should be injected after a </script> tag, should be injected before a <script> tag, or both. As shown in FIG. 2E, application script 112 may be injected after different <script> tags within web page application code. As shown in FIG. 2F, application script 112 may be inserted after a <body> tag in web page application code.

Referring now to FIG. 3, a flow diagram of a method 300 of automatically injecting an application script into application code is depicted. In some embodiments, method 300 may be initiated or performed by one or more processors in response to one or more instructions stored by a computer-readable storage medium.

At 302, method 300 includes injecting an application script at an automatically identified first location within application code of a particular web page such that the application script displaces a portion of the application code. For example, method 300 may include injection manager 108 injecting application script 112 at the location within web page application code 106 depicted in FIG. 2B.

At 304, method 300 includes sending, to a web browser, a first web response that includes the application code including the application script. For example, server system 104 may send, to web browser 102b, web response 124 including web page application code 106 and application script 112.

At 306, method 300 includes determining, based on whether metrics corresponding to the application script are received from the web browser in response to the first web response, whether to automatically identify a second location within the application score at which to instead inject the application script for a second web response. For example, based on whether metrics server 114 receives metrics 126 from web browser 102b, server system 104 may determine whether to automatically identify another location within web page application code 106 (e.g., the location depicted in FIG. 2C) at which to instead inject application script 112 for a second web response. The second web response may be sent to web browser 102b or to another web browser (e.g., web browser 102n in response to a web request). Accordingly, a method of automatically injecting an application script into application code is depicted.

Turning next to FIG. 4, a block diagram illustrating an exemplary embodiment of a computing system 400 that includes at least a portion of an automatic application script injection system. In some embodiments, computing system 400 includes or corresponds to some or all of server system 104 of FIG. 1, including any variations or modifications described previously with reference to FIGS. 1-3. In some embodiments, some or all elements of the computing system 400 may be included within a system on a chip (SoC). In some embodiments, computing system 400 is included in a mobile device. In the illustrated embodiment, the computing system 400 includes fabric 410, compute complex 420, input/output (I/O) bridge 450, cache/memory controller 445, and display unit 465.

Fabric 410 may include various interconnects, buses, MUXes, controllers, etc., and may be configured to facilitate communication between various elements of computing system 400. In some embodiments, portions of fabric 410 are configured to implement various different communication protocols. In other embodiments, fabric 410 implements a single communication protocol and elements coupled to fabric 410 may convert from the single communication protocol to other communication protocols internally.

In the illustrated embodiment, compute complex 420 includes bus interface unit (BIU) 425, cache 430, and cores 435 and 440. In some embodiments, cores 435 and 440 may correspond to various devices described herein, such as injection manager 108, metrics server 114, or error rate tracker 116. In various embodiments, compute complex 420 includes various numbers of cores and/or caches. For example, compute complex 420 may include 1, 2, or 4 processor cores, or any other suitable number. In some embodiments, cores 435 and/or 440 include internal instruction and/or data caches. In some embodiments, a coherency unit (not shown) in fabric 410, cache 430, or elsewhere in computing system 400 is configured to maintain coherency between various caches of computing system 400. BIU 425 may be configured to manage communication between compute complex 420 and other elements of computing system 400. Processor cores such as cores 435 and 440 may be configured to execute instructions of a particular instruction set architecture (ISA), which may include operating system instructions and user application instructions.

Cache/memory controller 445 may be configured to manage transfer of data between fabric 410 and one or more caches and/or memories (e.g., non-transitory computer readable mediums). For example, cache/memory controller 445 may be coupled to an L3 cache, which may, in turn, be coupled to a system memory. In other embodiments, cache/memory controller 445 is directly coupled to a memory. In some embodiments, the cache/memory controller 445 includes one or more internal caches. In some embodiments, the cache/memory controller 445 may include or be coupled to one or more caches and/or memories that include instructions that, when executed by one or more processors (e.g., compute complex 420), cause the processor, processors, or cores to initiate or perform some or all of the processes described above with reference to FIGS. 1-3.

As used herein, the term “coupled to” may indicate one or more connections between elements, and a coupling may include intervening elements. For example, in FIG. 4, display unit 465 may be described as “coupled to” compute complex 420 through fabric 410. In contrast, in the illustrated embodiment of FIG. 4, display unit 465 is “directly coupled” to fabric 410 because there are no intervening elements.

Display unit 465 may be configured to read data from a frame buffer and provide a stream of pixel values for display. Display unit 465 may be configured as a display pipeline in some embodiments. Additionally, display unit 465 may be configured to blend multiple frames to produce an output frame. Further, display unit 465 may include one or more interfaces (e.g., MIPI® or embedded display port (eDP)) for coupling to a user display (e.g., a touchscreen or an external display).

I/O bridge 450 may include various elements configured to implement: universal serial bus (USB) communications, security, audio, and/or low-power always-on functionality, for example. I/O bridge 450 may also include interfaces such as pulse-width modulation (PWM), general-purpose input/output (GPIO), serial peripheral interface (SPI), and/or inter-integrated circuit (I2C), for example. Various types of peripherals and devices may be coupled to computing system 400 via I/O bridge 450.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer-readable medium having program instructions stored thereon that, when executed by a computer server system, cause the computer server system to perform operations comprising:
injecting an application script at an automatically identified first location within application code of a particular web page such that the application script displaces a portion of the application code;
sending, to a web browser, a first web response that comprises the application code including the application script; and
determining, based on whether metrics corresponding to the application script are received from the web browser in response to the first web response, whether to automatically identify a second location within the application code at which to instead inject the application script for a second web response.

2. The non-transitory computer-readable medium of claim 1, wherein the automatically identified first location is indicated by a location byte indicator associated with the particular web page.

3. The non-transitory computer-readable medium of claim 2, wherein the operations further comprise, in response to automatically identifying the second location, modifying the location byte indicator to indicate the second location.

4. The non-transitory computer-readable medium of claim 3, wherein the operations further comprise, in response to modifying the location byte indicator a particular number of times, determining not to inject the application script into responses that include the application code of the particular web page.

5. The non-transitory computer-readable medium of claim 1, wherein automatically identifying the second location is performed using a set of location detection rules that specify one or more tags indicative of potential application script injection locations.

6. The non-transitory computer-readable medium of claim 1, wherein the operations further comprise, in response to failing to identify the second location using a set of location detection rules, determining not to inject the application script into a response that includes the application code of the particular web page.

7. The non-transitory computer-readable medium of claim 1, wherein the application script includes instructions that, when executed by a computer system, generate the metrics, wherein the metrics indicate a behavior of the application code when executed by the computer system.

8. The non-transitory computer-readable medium of claim 1, wherein the application script includes instructions to send the metrics to a metrics server.

9. The non-transitory computer-readable medium of claim 1, wherein the application script includes instructions to send the metrics to a web address corresponding to the particular web page.

10. The non-transitory computer-readable medium of claim 1, wherein the injecting the application script is performed prior to receiving a web request from the web browser, wherein the web request identifies the particular web page, and wherein the first web response is sent in response to the web request.

11. The non-transitory computer-readable medium of claim 1, wherein the injecting the application script is performed in response to a web request from the web browser, wherein the web request identifies the particular web page, and wherein the first web response is sent in response to the web request.

12. A non-transitory computer-readable medium having program instructions stored thereon that, when executed by a computer server system, cause the computer server system to perform operations comprising:
injecting an application script at an automatically identified first location within application code of a particular web page such that the application script displaces a portion of the application code;
sending, to a web browser, a first web response that comprises the application code including the application script;
determining an error rate corresponding to the application code including the application script;
comparing the error rate to an error threshold; and
in response to the error rate exceeding the error threshold, automatically identifying a second location within the application code at which to instead inject the application script for a second web response.

13. The non-transitory computer-readable medium of claim 12, wherein the operations further comprise, in response to the error threshold equaling or exceeding the error rate, sending, to a second web browser, a third web response that comprises the application script at the first location within the application code.

14. The non-transitory computer-readable medium of claim 12, wherein the first web response is one of a plurality of web responses that comprise the application script at the first location within the application code, and wherein the error rate is determined based on an amount of metrics received in response to the plurality of web responses.

15. The non-transitory computer-readable medium of claim 14, wherein the first web response is sent to the web browser in response to a web request, and wherein at least one of the plurality of web responses is sent to a second web browser in response to a second web request.

16. The non-transitory computer-readable medium of claim 14, wherein the plurality of web responses are sent to the web browser in response to a web request.

17. A method, comprising:
injecting, by a computer server system, an application script at an automatically identified first location within application code such that the application script displaces a portion of the application code, wherein the application code corresponds to a particular uniform resource locator (URL);
sending, by the computer server system to a web browser in response to a web request that specifies the particular URL, a first web response that comprises the application code including the application script; and
determining, by the computer server system, based on whether metrics corresponding to the application script are received from the web browser in response to the first web response, whether to automatically identify a second location within the application code at which to instead inject the application script for a second web response.

18. The method of claim 17, further comprising sending, to a second web browser, the second web response including the application script at the second location within the application code.

19. The method of claim 17, further comprising sending, to the web browser, the second web response including the application script at the second location within the application code.

20. The method of claim 17, further comprising, in response to an indication of an update to the application code, automatically identifying a particular location within the updated application code at which to inject the application script.
